(19) United States
(12) Patent Application Publication
(10) Pub. No.: US 2006/0023920 A1
(43) Pub. Date: Feb. 2, 2006

(54) Method and apparatus for matching individuals based on their mental connection

(76) Inventor: Gary Buslik, Mundelein, IL (US)

Correspondence Address: COOPER & DUNHAM, LLP, 1185 AVENUE OF THE AMERICAS, NEW YORK, NY, 10036, US

(21) Appl. No.: 11/180,221

(22) Filed: Jul. 13, 2005

Related U.S. Application Data
(60) Provisional application No. 60/592,416, filed on Jul. 29, 2004.

(51) Int. Cl. G06K 9/00

(52) U.S. Cl. 382/115

(57) ABSTRACT

Method and apparatus for matching individuals based on their mental connection. A repository for maintaining user identity and choice data is created. A plurality of images are provided to each of a group of individuals, where a different user identity is associated with each individual and is stored in the repository. Each of the individuals independently selects one or more images from the plurality of images. The selected one or more images are stored as the choice data in the repository for each of the individuals. The stored choice data is compared for each of the individuals and each individual is matched with one or more individuals who selected the same one or more images from the plurality of images.

### FIELD OF THE INVENTION

The present disclosure relates generally to a method for matching individuals and, more particularly, to methods and apparatuses for matching individuals based on their possible mental connection.

### BACKGROUND OF THE INVENTION

It may sometimes be difficult for individuals to meet other individuals having similar interests and personal characteristics. A number of services have been developed and offered over the years, which allow individuals to meet. These services typically allow a user to select specific criteria that they want a prospective match to have. For example, a user can select a preferred ethnicity, geographic location, religious affiliation, body type, educational level, etc. The user is then matched with other individuals that meet the criteria specified. In other systems, a user can answer a group of questions and can be matched with other individuals based on such answers.

However, these systems emphasize matching individuals based on compatibility as defined by a user or a group of predetermined values or criteria. While such systems may work for some individuals, they may not provide users with their ideal match. In other words, these systems do not match individuals based on their possible mental connection or similarity by testing their psychic compatibility. Accordingly, there is a need for reliable and effective ways to match individuals based on their mental connection or similarity.

### SUMMARY OF THE INVENTION

This application describes methods and apparatuses for matching individuals based on their possible, but previously unrecognized mental connection or similarity. A method for matching individuals based on their mental connection, according to one embodiment of the present disclosure, includes creating a repository for maintaining user identity data and choice data, providing a plurality of images to each of a group of individuals, wherein different user identity data is associated with each individual and is stored in the repository, allowing each of the individuals independently to select one or more images from the plurality of images, storing in the repository the selected one or more images as the choice data for each of the individuals, comparing the stored choice data for each of the individuals, and matching each individual with one or more individuals who selected the same one or more images from the plurality of images based on the choice data.

An apparatus for matching individuals based on their mental connection, according to one embodiment of the present disclosure, includes a repository for maintaining user identity and choice data, an image-providing layer for providing a plurality of images to each of a group of individuals, wherein different user identity data is associated with each individual and is stored in the repository, a image-selecting layer for allowing each of the individuals independently to select one or more images from the plurality of images, a storing layer for storing in the repository the selected one or more images as the choice data for each of the individuals, a comparing layer for comparing the stored choice data for each of the individuals, and a matching layer for matching each individual with one or more individuals who selected the same one or more images from the plurality of images based on the choice data.

The methods and apparatuses of this disclosure may be embodied in one or more computer programs stored on a computer readable medium or program storage device and/or transmitted via a computer network or other transmission medium. For example, a computer storage medium including computer executable code for matching individuals based on their mental connection, according to one embodiment of the present disclosure, includes code for creating a repository for maintaining user identity data and choice data, code for providing a plurality of images to each of a group of individuals, wherein different user identity data is associated with each individual and is stored in the repository, code for allowing each of the individuals independently to select one or more images from the plurality of images, code for storing in the repository the selected one or more images as the choice data for each of the individuals, code for comparing the stored choice data for each of the individuals, and code for matching each individual with one or more individuals who selected the same one or more images from the plurality of images based on the choice data.

### BRIEF DESCRIPTION OF THE DRAWINGS

The features of the present application can be more readily understood from the following detailed description with reference to the accompanying drawings wherein:

FIG. 1 shows a block diagram of an exemplary computer system capable of implementing the methods and apparatuses of the present disclosure;

FIG. 2A shows a block diagram illustrating an apparatus for matching individuals based on their mental connection, according to one embodiment of the present disclosure;

FIG. 2B shows a flow chart illustrating a method for matching individuals based on their mental connection, according to one embodiment of the present disclosure;

FIG. 3 shows a schematic diagram illustrating a method for matching individuals based on their mental connection using, for example, five matching levels and five images, according to one embodiment of the present disclosure;

FIG. 4 shows a block diagram illustrating a method for matching individuals based on their mental connection using, for example, five matching levels and five images, where the original group may have 5,000 individuals, according to one embodiment of the present disclosure;

FIG. 5 shows a block diagram illustrating a method for matching individuals based on their mental connection using, for example, five matching levels and five images where the original group may have 10,000 individuals, according to one embodiment of the present disclosure;

FIG. 6 shows a block diagram illustrating a method for matching individuals based on their mental connection using, for example, five matching levels and three images where the original group may have 1,000 individuals, according to one embodiment of the present disclosure;

FIG. 7 shows a block diagram illustrating a system for matching individuals based on their mental connection, according to one embodiment of the present disclosure;

FIG. 8 shows a flow chart illustrating how an individual may subscribe to an online service for matching individuals based on their mental connection, according to one embodiment of the present disclosure; and

FIG. 9 is a flow chart illustrating a method for matching individuals based on their mental connection in the subscriber area of an online service, according to one embodiment of the present disclosure.

### DETAILED DESCRIPTION OF THE PREFERRED EMBODIMENTS

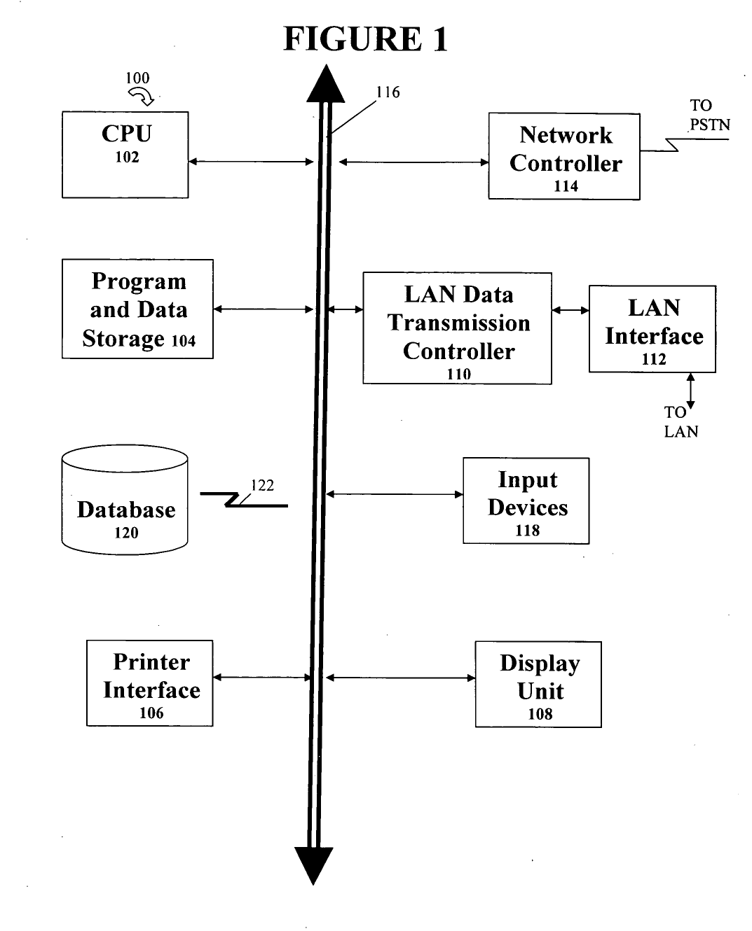

The present disclosure provides tools (in the form of methodologies, apparatuses, and systems) for matching individuals based on their mental connection. FIG. 1 shows an example of a computer system 100 which may implement the methods and apparatuses of the present disclosure. The apparatuses and methods of the present disclosure may be implemented in the form of a software application running on a computer system, for example, a mainframe, personal computer (PC), handheld computer, server, etc. The software application may be stored on a recording medium locally accessible by the computer system, for example, floppy disk, compact disk, hard disk, etc., or may be remote from the computer system and accessible via a hard wired or wireless connection to a network, (for example, a local area network, or the Internet, etc) or another transmission medium.

The computer system 100 can include a central processing unit (CPU) 102, program and data storage devices 104, a printer interface 106, a display unit 208, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

Stable, happy relationships between two parties are often successful if both parties mutually understand one another, an event typically referred to as “being on the same wavelength” or “being mentally connected”. When parties are on the same mental wavelength or are mentally connected, they may minimize their risk for relationship conflicts, arguments, and disagreements. The method and apparatus embodied in the present disclosure may provide individuals with companionship, friendship, or romantic involvement, but is not necessarily directed to a dating or match-making service. For some, it may be purely recreational, for others, it may be played as a game by participants unknown to each other, who may choose to remain anonymous.

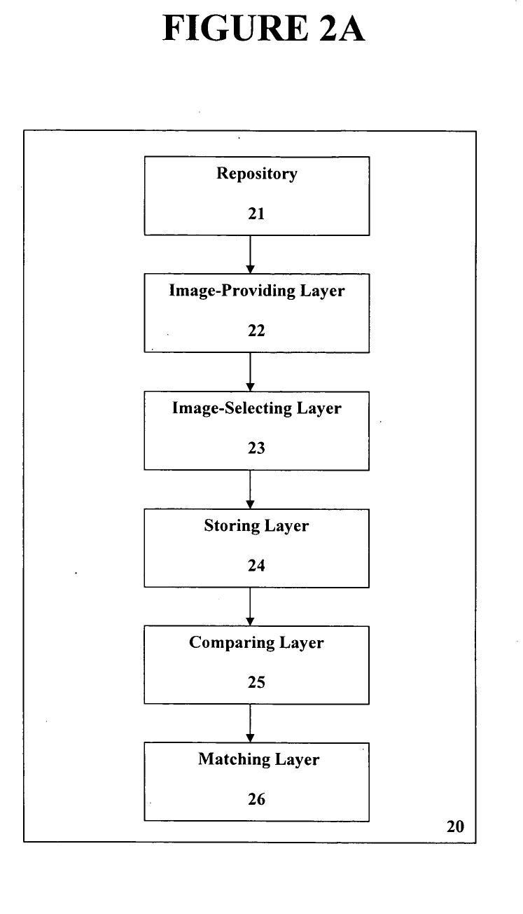

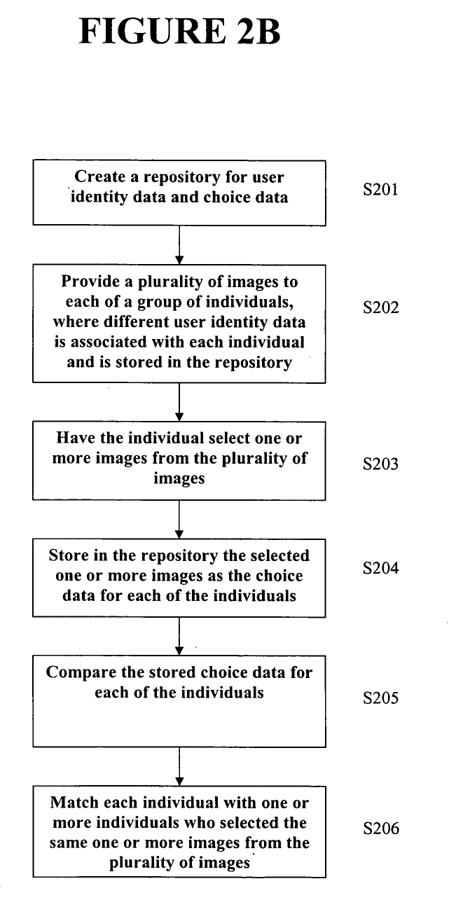

An apparatus for matching individuals based on their mental connection, according to one embodiment of this disclosure, will be discussed below with reference to FIG. 2A. The apparatus 20 includes a repository 21, an image-providing layer 22, an image-selecting layer 23, a storing layer 24, a comparing layer 25, and a matching layer 26.

A method for matching individuals based on their mental connection, will be explained below with reference to FIGS. 2A and 2B. A repository 21 is created for maintaining user identity data and choice data (Step S201). The image-providing layer 22 provides a plurality of images, or other randomly generated choices, to each of a group of individuals, where different user identity data is associated with each individual and is stored in the repository (Step S202). The image-selecting layer 23 allows the individual to select one or more images from the plurality of images provided by the image-providing layer 22 (Step S203). The storing layer 24 stores in the repository the selected one or more images as the choice data for each of the individuals (Step S204). The comparing layer 25 compares the stored choice data for each of the individuals (Step S205). The matching layer 26 matches each individual with one or more individuals who selected the same one or more images from the plurality of images, or made the same choice from among the several given (Step S206).

The method for matching individuals based on their mental connection may further comprise repeating Steps S202-S203 at least one time and performing at least one additional matching level, wherein the individual is matched with one or more individuals who selected the same one or more images from the plurality of images in both one or more of the previous matching levels and the present matching level. The matched individuals may be stored and reported when a matching is performed.

The image-providing layer 22 may provide images that comprise one or more shapes, colors, symbols, words, letters, numbers, pictures, etc., or any combination thereof. According to one embodiment of the present disclosure, the image-providing layer 22 may provide any number of images, for example, it may provide six images to any number of individuals, for example, one hundred individuals, for any number of matching levels, for example, five matching levels. An “image” is representative of one of several choices, and may be, for example, a conventional playing card.

The matching layer 26 may place the individual into a subgroup based on one or more images selected from the plurality of images. In addition, the individual may be placed into a subgroup based on the one or more images selected from the plurality of images for each additional matching level.

According to one embodiment of the present disclosure, the method and apparatus for matching individuals based on their mental connection may be used by individuals who may want to make new friends, form romantic relationships, and/or meet life partners, etc.

The figures depicted in this application discuss five matching levels, a variable number of images and a variable number of individuals for descriptive purposes only and should not be considered a limitation of the invention. It is to be understood that this invention can use any number of matching levels, any number of images and any number of participants and is not intended to be limited to the levels, images or individuals discussed and/or pictured herein.

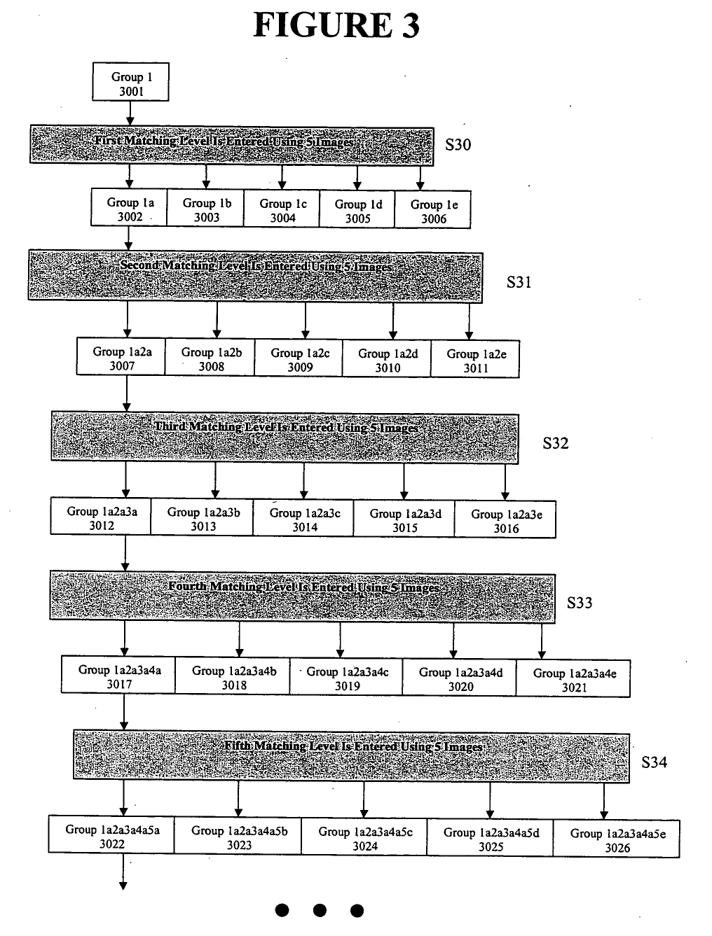

FIG. 3 is a schematic diagram illustrating a method of matching individuals based on their mental connection using, for example, five matching levels and five images, according to one embodiment of the present disclosure. It should be noted that for descriptive purposes, FIG. 3 only shows the second, third, fourth and fifth matching levels (or rounds) of the following groups and subgroups, respectively: group 1a 3002, group 1a2a 3007, group 1a2a3a 3012, and group 1a2a3a4a 3017 and is not intended to be limited to the groups described. For example, the individuals from group 1 3001 may select one of five provided images (or choices) and the first matching level may be entered (Step S30). Based on their selections, the individuals from group 1 3001 are then divided into five groups 1a-1e 3002-3006. These groups preferably should remain the same (except for possible attrition) until all matching levels are completed. In other words, new individuals may not be permitted to enter any of the groups in any of the matching levels. A second matching level may then be entered by each of the groups 1a-1e 3002-3006. For example, the individuals from group 1a 3002 may select one of five provided images and the second matching level may be entered (Step S31). Based on their selections in the second level, the individuals from group 1a 3002 are then divided into five sub-groups 1a2a-1a2e 3007-3011. Third level matching may then be performed by each of the sub-groups 1a2a-1a2e 3007-3011. For example, the individuals from sub-group 1a2a 3007 may select one of five provided images and the third matching level may be entered (Step S32). Based on their selections in the third level, the individuals from sub-group 1a2a 3007 may then be further divided into five additional sub-groups 1a2a3a-1a2a3e 3012-3016. The fourth matching level may then be entered by each of the additional sub-groups 1a2a3a-1a2a3e 3012-3016. For example, the individuals from subgroup 1a2a3a 3012 may select one of five provided images and the fourth matching level may be entered (Step S33). Based on their selections in the fourth level, the individuals from sub-group 1a2a3a 3012 may then be further divided into five more sub-groups 1a2a3a4a-1a2a3a4e 3017-3021. Fifth level matching may then be performed by each of the additional sub-groups 1a2a3a4a-1a2a3a4e 3017-3021. For example, the individuals from sub-group 1a2a3a4a 3017 may select one of five provided images and the fifth matching level may be entered (Step S34). Based on their selections in the fifth level, the individuals from sub-group 1a2a3a4a 3017 may be further divided into five additional sub-groups 1a2a3a4a5a-1a2a3a4a5e 3022-3026.

According to an embodiment of the present disclosure, each of the subgroups may have a certain specified time period by which to complete each matching level. For example, if an individual does not complete the second matching level in one week, that individual may not be permitted to complete any other matching levels.

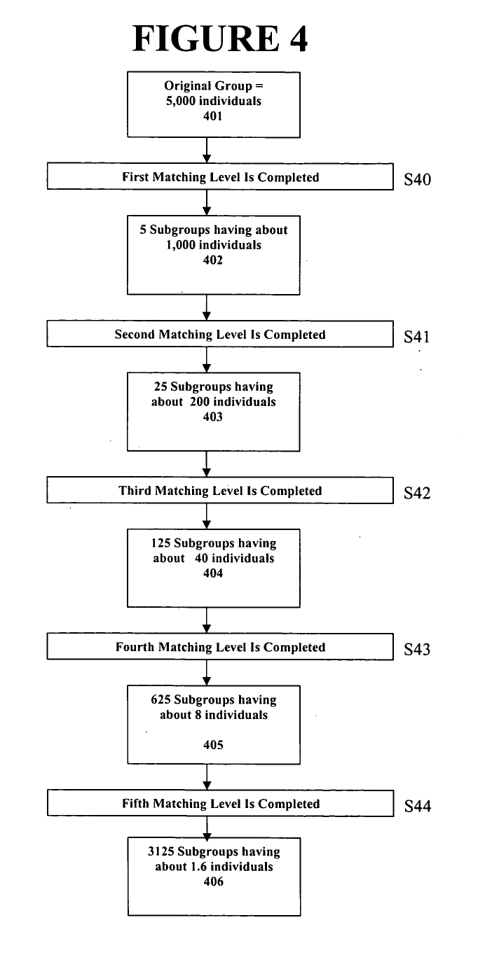

FIG. 4 is a block diagram illustrating a method for matching individuals based on their mental connection using, for example, five matching levels and five images, where the original group may have 5,000 individuals, according to one embodiment of the present disclosure. For example, original group 401 may have 5,000 individuals and after the first matching level is completed (Step S40), the individuals may be divided into 5 groups 402, where each group may have 1,000 individuals. After the second matching level is completed (Step S41), the 5 groups 402, each including 1,000 individuals may be further divided into 25 subgroups 403, where each subgroup may have 200 individuals. After the third matching level is completed (Step S42), the 25 subgroups 403 may be divided into 125 subgroups 404, where each subgroup may have 40 individuals. After the fourth matching level is completed (Step S43), the 125 subgroups 404 may be further divided into 625 subgroups 405, each including 8 individuals. Finally, after the fifth matching level is completed (Step S44), the 625 subgroups 405 may be divided into 3,125 subgroups 406, each including approximately 1.6 individuals. In other words, at the end of five matching levels, each individual from original group 401 may be matched to approximately 1.6 other mentally connected individuals.

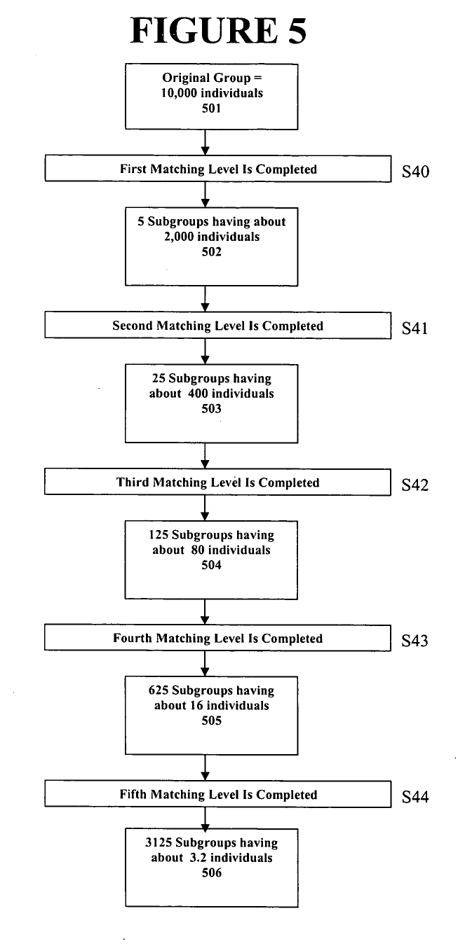

FIG. 5 is a block diagram illustrating a method for matching individuals based on their mental connection using, for example, five matching levels and five images, where the original group may have 10,000 individuals, according to one embodiment of the present disclosure. For example, original group 501 may have 10,000 individuals and after the first matching level is completed (Step S40), the individuals may be divided into 5 groups 502, where each group may have 2,000 individuals. After the second matching level is completed (Step S41), the 5 groups 502, each including 2,000 individuals may be further divided into 25 subgroups 503, where each subgroup may have 400 individuals. After the third matching level is completed (Step S42), the 25 subgroups 503 may be divided into 125 subgroups 504, where each subgroup may have 80 individuals. After the fourth matching level is completed (Step S43), the 125 subgroups 504 may be further divided into 625 subgroups 505, each including 16 individuals. Finally, after the fifth matching level is completed (Step S44), the 625 subgroups 505 may be divided into 3,125 subgroups 506, each including 3.2 individuals. In other words, at the end of five matching levels, each individual from original group 501 may be matched to approximately 3.2 other mentally connected individuals. The greater the number of individuals in the original group, the greater the number of potential matches for each individual. For example, if the original group has 5,000 individuals, each individual in the group may potentially be matched to approximately 1.6 mentally connected individuals, whereas if the original group has 10,000 individuals, those 10,000 individuals may potentially be matched to double that amount, or approximately 3.2 mentally connected individuals.

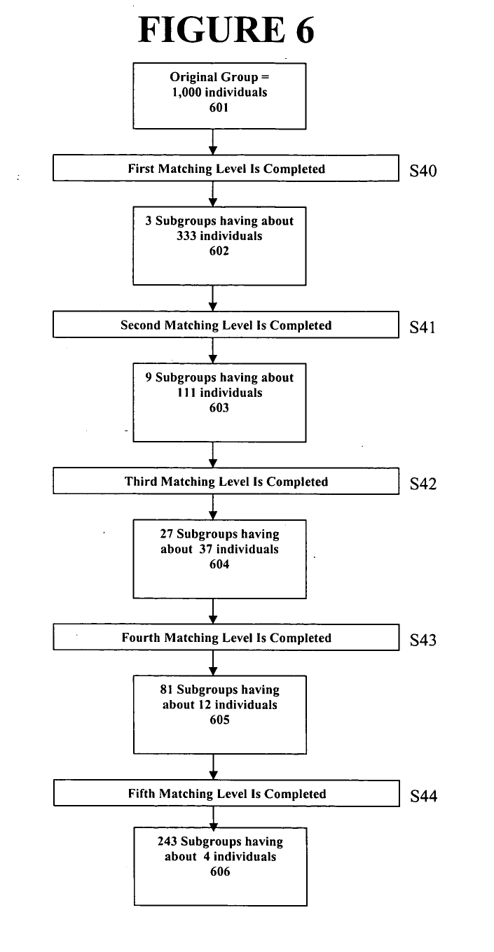

FIG. 6 is a block diagram illustrating a method for matching individuals based on their mental connection using, for example, five matching levels and three images, where the original group may have 1,000 individuals, according to one embodiment of the present disclosure. For example, original group 601 may have 1,000 individuals and after the first matching level is completed (Step S40), the individuals may be divided into 3 groups 602, where each group may have 333 individuals. After the second matching level is completed (Step S41), the 3 groups 602, each including 333 individuals may be further divided into 9 subgroups 603, where each subgroup may have 111 individuals. After the third matching level is completed (Step S42), the 9 subgroups 603 may be divided into 27 subgroups 604, where each subgroup may have 37 individuals. After the fourth matching level is completed (Step S43), the 27 subgroups 604 may be further divided into 81 subgroups 605, each including 12 individuals. Finally, after the fifth matching level is completed (Step S44), the 81 subgroups 605 may be divided into 243 subgroups 606, each including 4 individuals. In other words, at the end of five matching levels, each individual from original group 601 may be matched to approximately 4 other mentally connected individuals.

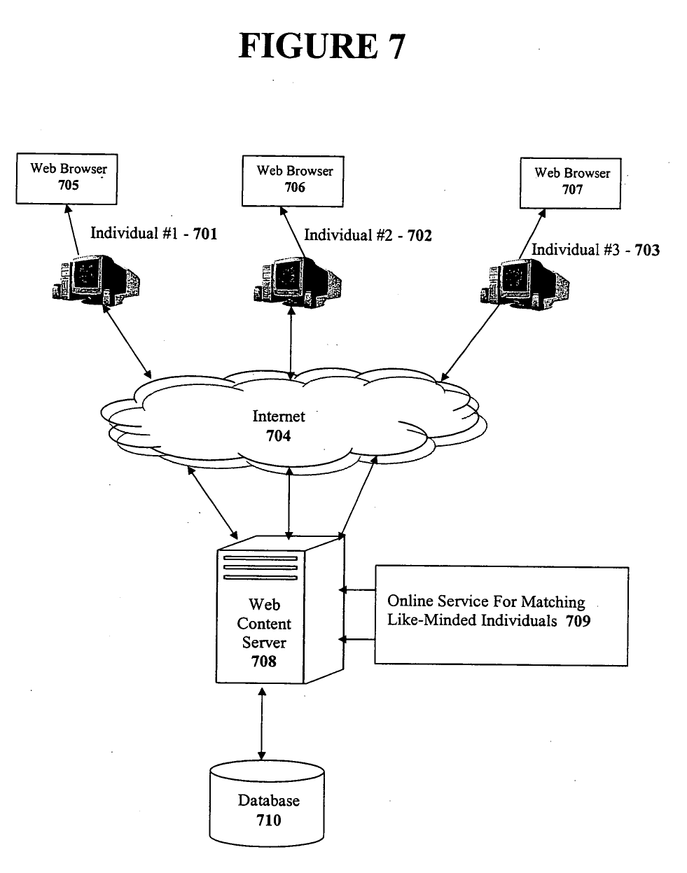

According to one embodiment of the present disclosure, the method of the present disclosure may be implemented through an Internet based online service. FIG. 7 is a block diagram illustrating a system for matching individuals based on their mental connection, according to one embodiment of the present disclosure. One or more individuals 701, 702, 703 may access the service via for example, the Internet 704 by using for example, a mobile phone, personal digital assistant, laptop computer, desktop computer, or some other device capable of accessing the Internet. Requests for web content provided by the online service for matching individuals based on their mental connection 709 may be sent by each individuals 701, 702, 703 web browser 705, 706, 707 through the Internet 704 to the web content server 708. The web content server 708 may respond to the requests sent by the web browsers 705, 706, 707 and provide access to the content provided by the online service for matching individuals based on their mental connection 709 through the Internet 704. Web browsers 705, 706, 707, such as Internet Explorer, Netscape Navigator, etc., may be used to display the content provided by the online service for matching individuals based on their mental connection 709. A database 710 may be used by the online service for matching individuals based on their mental connection 709 to store information, such as account information relating to individuals 701, 702, 703 who subscribe to the online service.

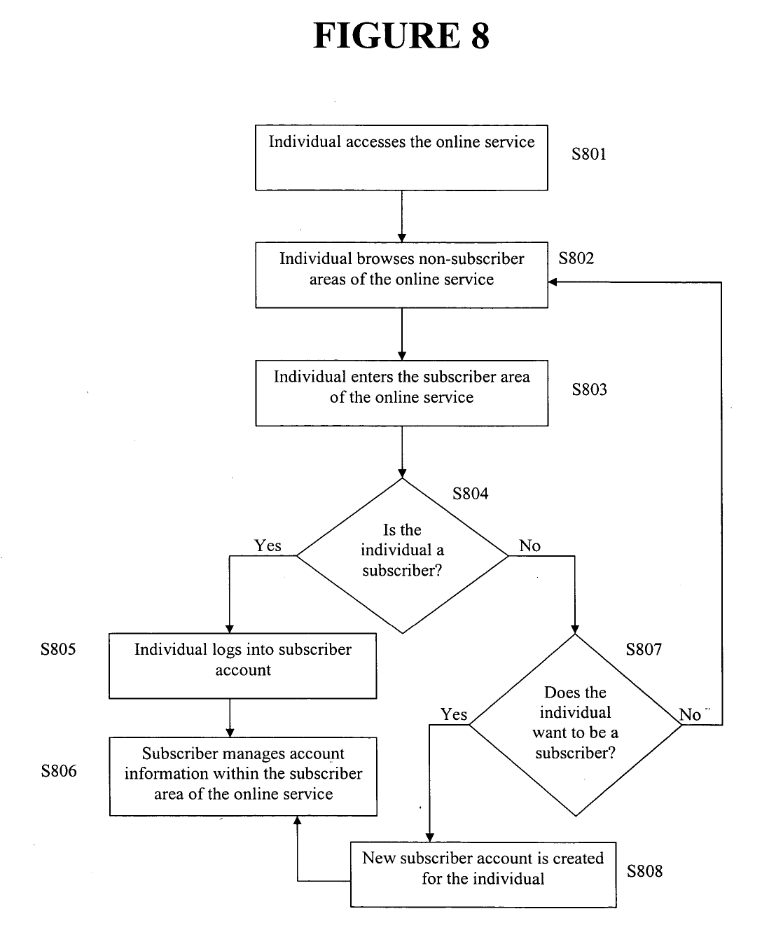

FIG. 8 is a flow chart illustrating how an individual may subscribe to an online service for matching individuals based on their mental connection, according to one embodiment of the present invention. The subscription process will be described with reference to FIGS. 7 and 8. An individual 701 may access the online service for matching individuals based on their mental connection 709 through the Internet 704 (Step S801). The individual 701 may browse the non-subscriber areas of the online service 709 (Step S802). For example, one non-subscriber area of the online service may provide individuals with calisthenics exercises to improve their psychic abilities by trying to outguess the computer. If the individual 701 enters the subscriber area of the line service 709, it can be determined whether the individual 701 is a subscriber (Step S804). If the individual 701 is a subscriber (Yes, Step S804), the online service 709 can log the individual 701 into his/her subscriber account (Step S805). The individual 701 can then manage his/her account information in the subscriber area of the online service 709 (Step S806). However, if the individual 701 is not a subscriber (No, Step S804), the individual 701 is allowed to subscribe (Step S807). If the individual 701 does not wish to subscribe (No, Step S807), the individual 701 may continue to browse the non-subscriber areas of the online service 709 (Step S802). If the individual chooses to subscribe (Yes, Step S807), the online service 709 can create a new subscriber account for the individual 701 (Step S808). The individual 701 may then manage his or her account information in the subscriber area of the online service 709 (Step S806).

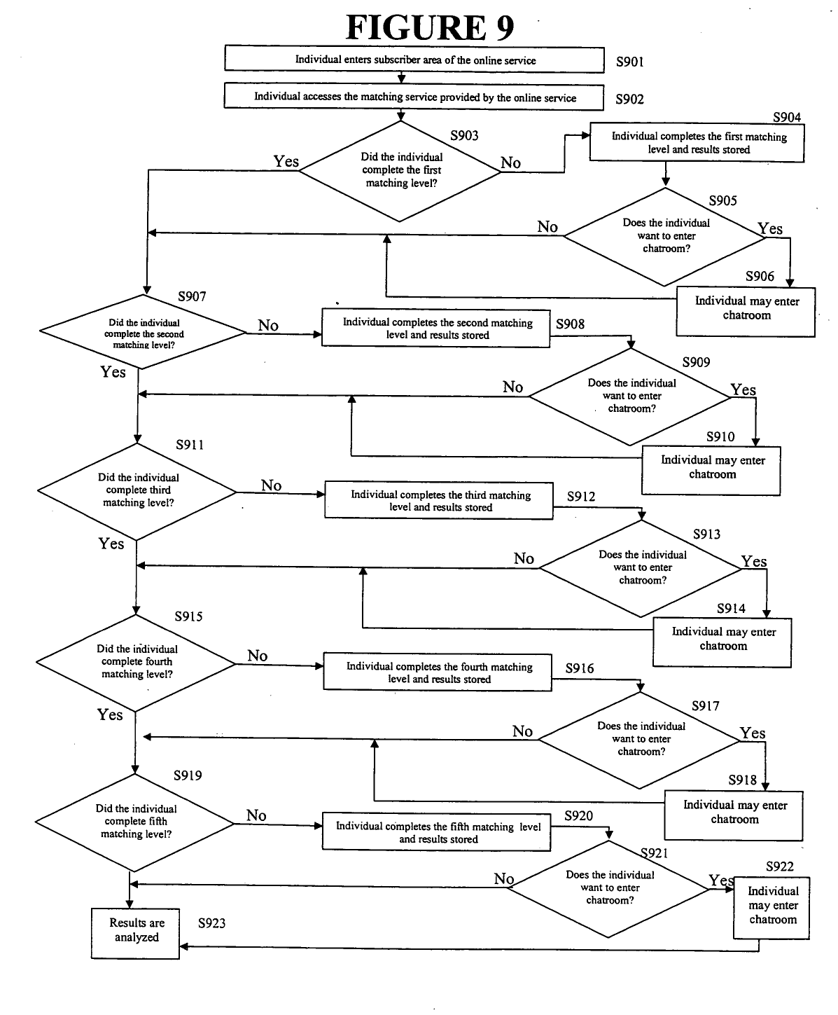

FIG. 9 is a flow chart illustrating the method of matching individuals based on their mental connection in the subscriber area of the online service, according to one embodiment of the present disclosure. The method will be described with reference to FIGS. 7 and 9. An individual 701 enters the subscriber area of the online service for matching individuals based on their mental connection 709 (Step S901) and accesses a matching service (Step S902) provided by the online service 709. Steps 901 and 902 are performed only if the individual 701 is a subscriber. It can first be determined whether the individual 701 has completed the first matching level (Step S903). If it is determined that the individual 701 has not completed the first matching level (No, Step S903), the individual 701 may complete the first matching level and the results are stored (Step S904). It may then be determined whether the individual wants to enter a chatroom (Step S905). If the individual decides to enter the chatroom (Yes, Step S905), then he/she may do so (Step S906). However, if the individual 701 does not want to enter the chatroom (No, Step S905) or has completed the first matching level (Yes, Step S903), it may be determined if the individual 701 has completed the second matching level (Step S907). If the individual 701 has not completed the second matching level (No, Step S907), then the individual 701 may complete the second matching level and the results are stored (Step S908). It may then be determined whether the individual wants to enter a chatroom (Step S909). If the individual decides to enter the chatroom (Yes, Step S909), then he/she may do so (Step S910). However, if the individual 701 does not want to enter the chatroom (No, Step S909) or has completed the second matching level (Yes, Step S905), then it may be determined if the third matching level has been completed (Step S911). If third matching level has not been completed (No, Step S911), the individual 701 may complete third matching level and the results are stored (Step S912). It may then be determined whether the individual wants to enter a chatroom (Step S913). If the individual decides to enter the chatroom (Yes, Step S913), then he/she may do so (Step S914). However, if the individual 701 does not want to enter the chatroom (No, Step S913) or the individual 701 has completed the third matching level (Yes, Step S911), then it may be determined if fourth matching level has also been completed (Step S915). If fourth matching level has not been completed (No, Step S915), the individual 701 may complete fourth matching level and the results are stored (Step S916). It may then be determined whether the individual wants to enter a chatroom (Step S917). If the individual decides to enter the chatroom (Yes, Step S917), then he/she may do so (Step S918). However, if the individual 701 does not want to enter a chatroom (No, Step S917) or if the individual 701 did complete the fourth matching level (Yes, Step S915), then it may be determined if fifth matching level has been completed (Step S919). If fifth matching level has not been completed (No, Step S919), the individual 701 may complete the fifth matching level and the results are stored (Step S920). It may then be determined whether the individual wants to enter a chatroom (Step S921). If the individual decides to enter the chatroom (Yes, Step S921), then he/she may do so (Step S922). If the individual does not want to enter the chatroom (No, Step S921), then the results are analyzed (Step S923). Once the fifth matching level is completed (Yes, Step S919), the results from all the matching levels are analyzed (Step S923) to match the individual 701 with one or more their mentally connected individuals.

According to one embodiment of the present disclosure, once an individual is matched with one or more their mentally connected individuals, a compatibility checklist may be utilized to discover additional information about each individual. In addition, additional games and exercises may also be provided to further verify compatibility.

Numerous additional modifications and variations of the present disclosure are possible in view of the above-teachings. It is therefore to be understood that within the scope of the appended claims, the present disclosure may be practiced other than as specifically described herein.

What is claimed is:

1. A method for matching individuals based on their mental connection, comprising:
(a) creating a repository for maintaining user identity data and choice data;
(b) providing a plurality of images to each of a group of individuals, wherein different user identity data is associated with each individual and is stored in the repository;
(c) allowing each of the individuals independently to select one or more images from the plurality of images;
(d) storing in the repository the selected one or more images as the choice data for each of the individuals;
(e) comparing the stored choice data for each of the individuals; and
(f) matching each individual with one or more individuals who selected the same one or more images from the plurality of images based on the choice data.

2. The method of claim 1, further comprising repeating steps (b) and (c) at least one time and performing at least one additional matching level, wherein the individual is matched with one or more individuals who selected the same one or more images from the plurality of images in both one or more of the previous matching levels and the present matching level.

3. The method of claim 2, further comprising storing and reporting the matched individuals when a matching level is completed.

4. The method of claim 1, wherein the plurality of images comprise one or more shapes, colors, symbols, words, letters, numbers, pictures or a combination of shapes, colors, symbols, words, letters, numbers, and/or pictures.

5. The method of claim 1, wherein the performing step further comprises placing the individual into a group based on the one or more images selected from the plurality of images.

6. The method of claim 2, further comprising placing the individual into a subgroup based on the one or more images selected from the plurality of images for each additional matching level.

7. The method of claim 5, wherein the number of groups and number of subgroups are equal to the number of images provided.

8. An apparatus for matching individuals based on their mental connection, comprising:
a repository for maintaining user identity and choice data;
an image-providing layer for providing a plurality of images to each of a group of individuals, wherein different user identity data is associated with each individual and is stored in the repository;
an image-selecting layer for allowing each of the individuals independently to select one or more images from the plurality of images;
a storing layer for storing in the repository the selected one or more images as the choice data for each of the individuals;
a comparing layer for comparing the stored choice data for each of the individuals; and
a matching layer for matching each individual with one or more individuals who selected the same one or more images from the plurality of images based on the choice data.

9. The apparatus of claim 8, further comprising means for performing at least one additional matching level, wherein the individual is matched with one or more individuals who selected the same one or more images from the plurality of images in both one or more of the previous matching levels and the present matching level.

10. The apparatus of claim 9, further comprising means for storing and reporting the matched individuals when a matching level is completed.

11. The apparatus of claim 8, wherein the plurality of images comprise one or more shapes, colors, symbols, words, letters, numbers, pictures or a combination of shapes, colors, symbols, words, letters, numbers and/or pictures.

12. The apparatus of claim 8, wherein the individual matching layer further comprises means for placing the individual into a group based on the one or more images selected from the plurality of images.

13. The apparatus of claim 9, further comprising means for placing the individual into a subgroup based on the one or more images selected from the plurality of images for each additional matching level.

14. The apparatus of claim 12, wherein the number of groups and number of subgroups are equal to the number of images provided.

15. A computer system comprising:
a processor; and
a program storage device readable by the computer system, tangibly embodying a program of instructions executable by the processor to perform the method claimed in claim 1.

16. A program storage device readable by a machine, tangibly embodying a program of instructions executable by the machine to perform the method claimed in claim 1.

17. A computer data signal transmitted in one or more segments in a transmission medium which embodies instructions executable by a computer to perform the method claimed in claim 1.

18. A computer readable storage medium including computer executable code for matching individuals based on their mental connection, comprising:
(a) code for creating a repository for maintaining user identity data and choice data;
(b) code for providing a plurality of images to each of a group of individuals, wherein different user identity data is associated with each individual and is stored in the repository;
(c) code for allowing each of the individuals independently to select one or more images from the plurality of images;
(d) code for storing in the repository the selected one or more images as the choice data for each of the individuals;
(e) code for comparing the stored choice data for each of the individuals; and
(f) code for matching each individual with one or more individuals who selected the same one or more images from the plurality of images based on the choice data.

19. The computer readable storage medium of claim 18, further comprising code for repeating steps (b) and (c) at least one time and code for performing at least one additional matching level, wherein the individual is matched with one or more individuals who selected the same one or more images from the plurality of images in both one or more of the previous matching levels and the present matching level.

20. The computer readable storage medium of claim 19, further comprising code for storing and code for reporting the matched individuals when a matching level is completed.

21. The computer readable storage medium of claim 18, wherein the plurality of images comprise one or more shapes, colors, symbols, words, letters, numbers, pictures or a combination of shapes, colors, symbols, words, letters, numbers and/or pictures.

22. The computer readable storage medium of claim 18, wherein the code for performing further comprises code for placing the individual into a group based on the one or more images selected from the plurality of images.

23. The computer readable storage medium of claim 19, further comprising code for placing the individual into a subgroup based on the one or more images selected from the plurality of images for each additional matching level.

24. The computer readable storage medium of claim 22, wherein the number of groups and number of subgroups are equal to the number of images provided.
